(19) United States
(12) Patent Application Publication
(10) Pub. No.: US 2013/0318636 A1
(43) Pub. Date: Nov. 28, 2013

(54) COMPUTER CHASSIS WITH PROTECTION AGAINST INSECTS

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: Hai-Qing ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/781,821

(22) Filed: Mar. 1, 2013

(30) Foreign Application Priority Data
May 25, 2012 (CN) 201210165556.7

(51) Int. Cl. G06F 21/86

(52) U.S. Cl. CPC G06F 21/86
USPC 726/34

(57) ABSTRACT

A computer chassis includes a chassis body, a control unit, a motor unit, a gate unit and a detection unit. The chassis body defines an opening. The motor unit is electronically connected to the control unit. The gate unit is connected to the motor unit. The detection unit is electronically connected to the control unit. The gate unit and the detection unit are positioned in the opening, the detection unit detects and sends a detection signal to the control unit, the control unit receives the detection signal and control the motor unit to closes the gate unit.

### BACKGROUND

1. Technical Field

The disclosure generally relates to a computer chassis that is protective against insects.

2. Description of the Related Art

A computer chassis usually has a plurality of holes or openings, some of which are used for dissipating heat, some of which might be used as ports. However, insects might enter into the computer chassis through the holes or openings. The insects might damage or contaminate the inner structure of the computer chassis.

Therefore, there is room for improvement within the art.

### BRIEF DESCRIPTION OF THE DRAWINGS

Many aspects of an exemplary computer chassis with protection against insects can be better understood with reference to the following drawings. The components in the drawings are not necessarily drawn to scale, the emphasis instead being placed upon clearly illustrating the principles of the exemplary computer chassis. Moreover, in the drawings, like reference numerals designate corresponding parts throughout the several views. Wherever possible, the same reference numbers are used throughout the drawings to refer to the same or like elements of an embodiment.

FIG. 1 is a block diagram of a computer chassis with a control unit, a motor unit, a gate unit, a power unit, a detection unit and an alarm unit according to an exemplary embodiment.

FIG. 2 is a block diagram of the power unit electronically connected to the control unit, the motor unit and the detection unit of the computer chassis.

FIG. 3 is a schematic view of the gate unit, the alarm unit and the detection unit located on an opening of the computer chassis.

### DETAILED DESCRIPTION

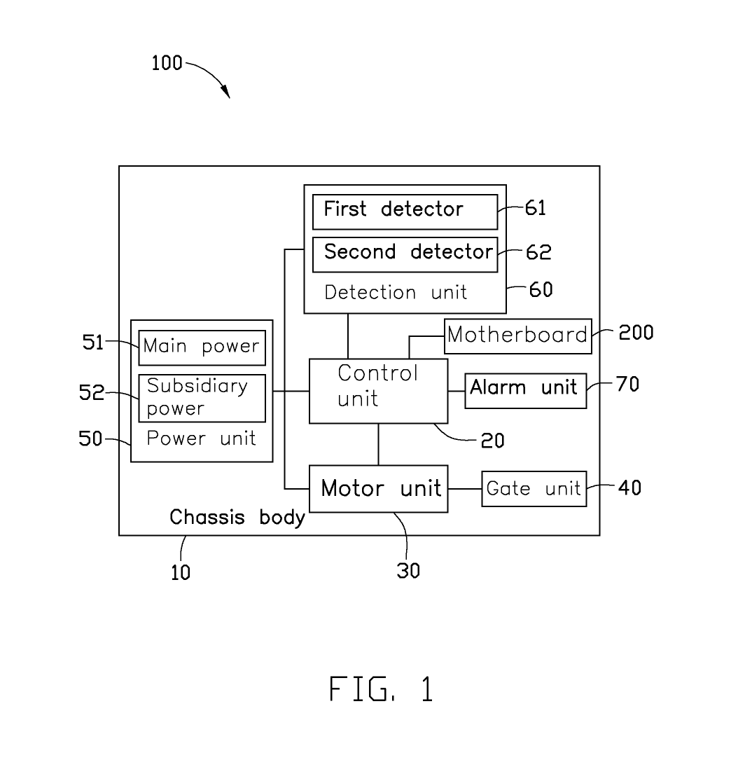

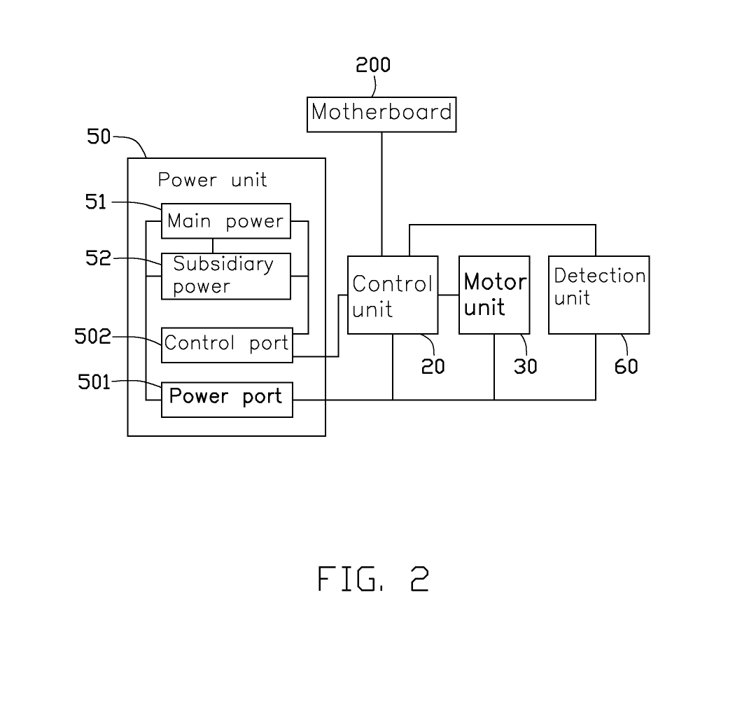

FIGS. 1 and 2 show an exemplary embodiment of a computer chassis 100 including a chassis body 10, a control unit 20, a motor unit 30, a gate unit 40, a power unit 50, a detection unit 60 and an alarm unit 70.

The chassis body 10 is a housing of a computer, and can contain a motherboard 200 and other inner circuits of the computer. The control unit 20, the mother unit 30, the gate unit 40, the power unit 50, the detection unit 60, and the alarm unit 70 are received in the chassis body 10.

The control unit 20 may be a single and independent microcontroller, or may be integrated with the central processing unit (CPU) of the motherboard 200 of the computer. The control unit 20 is electronically connected to the CPU. The control unit 20 can detect a work voltage of the motherboard 200 to determine a work state of the computer.

The motor unit 30 is electronically connected to the control unit 20. The motor unit 30 may be a step motor. The control unit 20 can control the motor unit 30 to rotate along a clockwise or counterclockwise direction. The gate unit 40 is electronically connected to the motor unit 30. When the motor unit 30 rotates along the counterclockwise or clockwise direction, the gate unit 40 can be driven to open or close an opening of the computer chassis 10.

The power unit 50 supplies the power for the control unit 20, the motor unit 30 and the detection unit 60. The control unit 20, the motor unit 30 and the detection unit 60 are electronically connected to the power unit 50. Referring to FIG. 2, the power unit 50 includes a main power 51, a subsidiary power 52, a power port 501, and a control port 502. The main power 51 may be a single battery, or may be integrated with the computer power. The subsidiary power 52 may be a rechargeable battery. The main power 51 and the subsidiary power 52 are electronically connected to the power port 501 and the control port 502. The main power 51 is electronically connected to the subsidiary power 52. The power port 501 is electronically connected to the control unit 20, the motor unit 30, and the detection unit 60 to supply power to the control unit 20, the motor unit 30 and the detection unit 60. The control port 502 is electronically connected to the control unit 20 to allow the control unit 20 to control the main power 51 and the subsidiary power 52 through the control port 502.

The detection unit 60 is an infrared detection apparatus, and includes a first detector 61 and a second detector 62. The first detector 61 and the second detector 62 are electronically connected to the control unit 20 to send a signal indicative of detection of the detector 61, 62 to the control unit 20.

The alarm unit 70 may be an LED, a speaker, or a combination thereof. The alarm unit 70 is electronically connected to the control unit 20, and is controlled by the control unit 20 to turn on a light or increase/decrease a volume.

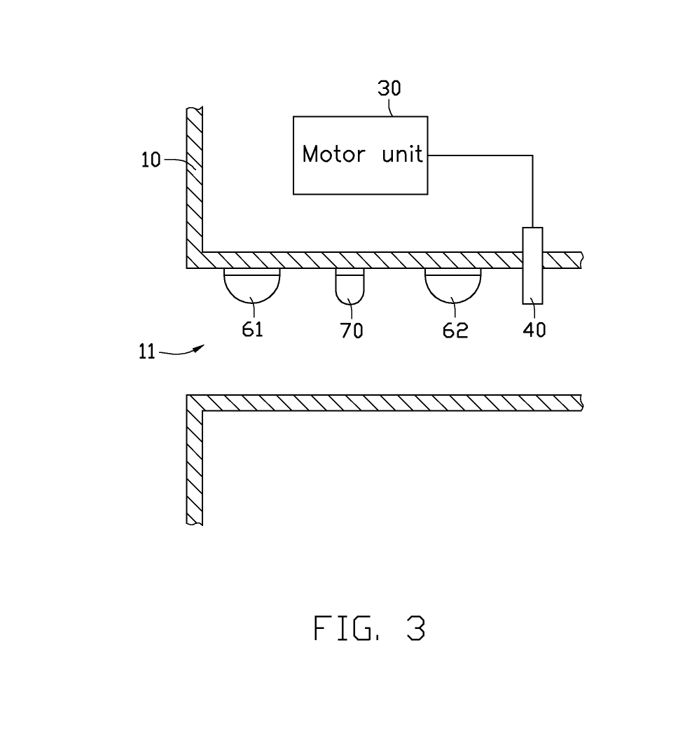

Referring to FIG. 3, during assembly, the gate unit 40, the first detector 61, the second detector 62 are located in an opening 11 of the chassis body 10. In the exemplary embodiment, the first detector 61, the alarm unit 70, the second detector 62 and the gate unit 40 are orderly positioned on an inner wall of the opening 11.

When the computer is turned on, the opening 11 needs to be opened for dissipation of heat. The main source 51 supplies power to the control unit 20, the motor unit 30 and the detection unit 60 via the power port 501. At the same time, the main source 51 charges the subsidiary source 52. The control unit 20 determines a work voltage of the motherboard 200. When the work voltage of the motherboard 200 is greater than a predetermined value, the control unit 20 will determine the motherboard 200 is at a normal state and control the motor unit 30 to rotate along a clockwise direction. The motor unit 30 further opens the gate unit 40 to open the opening 11.

If an insect enters into the opening 11, the first detector 61 first detects presence of the insect via infrared rays of the first detector 61, and sends a detection signal to the control unit 20. The control unit 20 receives the detection signal, and activates the alarm unit 70. The alarm unit 70 activates and produces sound and/or light. This will inform the user that insects are inside the computer chassis. Alternatively, the light or sound might scare the insects away from the opening 11. If the insect entering into the opening 11 is away from the opening 11, the first detector 61 will stop detecting. The control unit 20 will turn off the alarm unit 70 when the first detector 61 does not send the detecting signal.

If the insect entering into the opening 11 further moves toward the second detector 62, the second detector 62 will detect the insect, and send a detection signal to the control unit 20. When the control unit 20 receives the detection signal of the second detector 62, the control unit 20 will control the motor unit 30 to rotate counterclockwise. The gate unit 40 moves to close the opening 11 for preventing the insect from entering into the opening 11.

In another exemplary embodiment, the control unit 20 may control the gate unit 40 to keep a closed state at a predetermined time. The user can use the predetermined time to remove the insect. The control unit 20 will control the motor unit 30 to open the gate unit 40 after the predetermined time.

When the computer is turned off, the work voltage of the motherboard 200 is decreased to zero. The control unit 20 compares the work voltage to be lower than the predetermined voltage, the control unit 20 will determine the computer has been closed. The control unit 20 controls the control port 502 to turn on the subsidiary source 52. The subsidiary source 52 supplies the control unit 20 and the motor unit 30. At the same time, the control unit 20 controls the motor unit 30 to close the gate unit 40. Accordingly, the opening 11 is closed and the computer chassis is protected from the insects.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A computer chassis, comprising:
a chassis body defining an opening;
a control unit;
a motor unit electronically connected to the control unit;
a gate unit connected to the motor unit; and
a detection unit electronically connected to the control unit;
wherein the gate unit and the detection unit are positioned in the opening, the detection unit detects and sends a detection signal according to the detection to the control unit, the control unit receives the detection signal and controls the motor unit to close the gate unit.

2. The computer chassis as claimed in claim 1, further comprising an alarm unit, wherein the alarm unit is electronically connected to the control unit, the alarm unit activates if the control unit receives the detection signal.

3. The computer chassis as claimed in claim 1, wherein the diction unit includes a first detector and a second detector, the first detector, the alarm unit, the second detector and the gate unit are orderly positioned in the opening.

4. The computer chassis as claimed in claim 1, further comprising a power unit, wherein the power unit is electronically connected to the control unit, the motor unit and the detection unit for supplying power.

5. The computer chassis as claimed in claim 4, wherein the power unit includes a main source, a subsidiary source, a power port and a control port, the main power and the subsidiary power are electronically connected to the power port and the control port, the main power is electronically connected to the subsidiary power, the power port is electronically connected to the control unit, the motor unit, and the detection unit for supplying the control unit, the motor unit and the detection unit, the control port is electronically connected to the control unit for allowing the control unit to control the main power and the subsidiary power through the control port.

6. A computer chassis, comprising:
a control unit;
a motor unit electronically connected to the control unit;
a gate unit connected to the motor unit; and
a detection unit electronically connected to the control unit;
wherein the detection unit detects and sends a detection signal according to the detection to the control unit, the control unit receives the detection signal and controls the motor unit to close the gate unit.

7. The computer chassis as claimed in claim 6, further comprising an alarm unit, wherein the alarm unit is electronically connected to the control unit, the alarm unit activates if the control unit receives the detection signal.
